(19) United States
(12) Patent Application Publication
(10) Pub. No.: US 2023/0384759 A1
(43) Pub. Date: Nov. 30, 2023

(54) INFORMATION PROCESSING METHOD AND INFORMATION PROCESSING DEVICE

(71) Applicant: Panasonic Intellectual Property Management Co., Ltd., Osaka (JP)

(72) Inventors: Hironori OHIGASHI, Osaka (JP); Akira MINEGISHI, Osaka (JP); Yuta SHIMAZAKI, Osaka (JP); Yukinori SASAKI, Hyogo (JP)

(21) Appl. No.: 18/249,467

(22) PCT Filed: Oct. 29, 2021
(86) PCT No.: PCT/JP2021/040121

§ 371 Date: Apr. 18, 2023

(30) Foreign Application Priority Data
Nov. 2, 2020 (JP) 2020-183516

(51) Int. Cl. G05B 19/4065

(52) U.S. Cl. CPC G05B 19/4065; G05B 2219/40335

(57) ABSTRACT

An information processing method includes: calculating a probability density distribution of a work time that is at least part of a setup time, based on production performance data read from storage, the setup time being time taken for a setup work that is performed between lots; determining whether the work time is anormal, based on the probability density distribution; and outputting a result of the determining.

### CROSS-REFERENCE OF RELATED APPLICATIONS

This application is the U.S. National Phase under 35 U.S.C. § 371 of International Patent Application No. PCT/JP2021/040121, filed on Oct. 29, 2021, which in turn claims the benefit of Japanese Patent Application No. 2020-183516, filed on Nov. 2, 2020, the entire disclosures of which applications are incorporated by reference herein.

### TECHNICAL FIELD

The present disclosure relates to an information processing method and an information processing device.

### BACKGROUND ART

Patent literature (PTL) 1 discloses a bottleneck process specification device that determines the productivity of a process on the basis of the setup time that corresponds to such process, and specifies the bottleneck process on the basis of the determined productivity.

### CITATION LIST

### Patent Literature

[PTL 1] Japanese Patent No. 6703836
[PTL 2] WO 2020/166236

### SUMMARY OF INVENTION

### Technical Problem

The present disclosure aims to provide an information processing method and an information processing device capable of accurately determining whether a setup time is anormal.

### Solution to Problem

The information processing method according to an aspect of the present disclosure includes: calculating a probability density distribution of a work time that is at least part of a setup time, based on production performance data read from storage, the setup time being time taken for a setup work that is performed between lots; determining whether the work time is anormal, based on the probability density distribution; and outputting a result of the determining.

The information processing device according to an aspect of the present disclosure includes: a calculator that calculates a probability density distribution of a work time that is at least part of a setup time, based on production performance data read from storage, the setup time being time taken for a setup work that is performed between lots; a determiner that determines whether the work time is anormal, based on the probability density distribution; and an outputter that outputs a determination result of the determiner.

An aspect of the present disclosure can be implemented as a program for causing a computer to execute the foregoing information processing method. Alternatively, an aspect of the present disclosure can be implemented as a non-transitory computer-readable recording medium that stores such program.

### Advantageous Effects of Invention

According to the present disclosure, it is possible to accurately determine whether a setup time is anormal.

### BRIEF DESCRIPTION OF DRAWINGS

FIG. 1 is a diagram showing the details of a process lead time.

FIG. 2 is a diagram showing the relation between manufacturing times and setup works required to manufacture a plurality of lots.

FIG. 3 is a diagram showing the details of a setup time.

FIG. 4 is a block diagram showing the functional configuration of a production anomaly estimation device according to an embodiment.

FIG. 5 is a diagram for describing a process performed by a manufacturing time estimator.

FIG. 6 is a diagram for describing a process performed by a setup time estimator.

FIG. 7 is a diagram for describing a process performed by a process lead time estimator.

FIG. 8 is a diagram for describing an anomaly level calculation method.

FIG. 9 is a diagram showing the occurrence of an anomaly in a process lead time.

FIG. 10 is a diagram for describing a degree of impact calculation method.

FIG. 11 is a diagram showing an example of the calculated degrees of impact.

FIG. 12 is a flowchart showing an operation performed by the production anomaly estimation device according to the embodiment.

### DESCRIPTION OF EMBODIMENT

### (Underlying Knowledge Forming Basis of the Present Disclosure)

Mass production of a small variety of products used to be common practice in traditional manufacturing workplaces. There, a small number of setup works was involved such as product changeover. Also, setup works were conducted by expertized workers who were accustomed to them after repeatedly performing the same works. For this reason, small variations were present among setup times taken for the setup works, and such setup times were minor times compared to the manufacturing times.

In recent manufacturing workplaces, however, a wider variety of products have been produced. Also, the number of products produced per product type is getting smaller. For this reason, an increased number of setup works needs to be performed, with each setup work involving a wide range of works. Also, due to a decreased number of expertized workers, setup times include significant variations, forming an increasing proportion of a process lead time.

Under these circumstances, the mere reduction in the manufacturing time, which is the time taken for the manufacture of products, is not enough to improve the production efficiency. From the standpoint of improving the production efficiency, reduction in setup times is required.

Setup times depend, for example, on the details of setup works, equipment, or workers. For example, depending on the details of the setup works, both cases can occur where significant time reduction is possible and time reduction is virtually impossible. For this reason, it is required to appropriately identify the setup time that can be reduced. The setup time that can be reduced is the time taken long for the completion of the setup which should have been completed in a shorter time. Stated differently, the setup time that can be reduced is an anormal setup time.

In view of this, the present disclosure aims to provide an information processing method and an information processing device capable of accurately determining whether a setup time is anormal.

The information processing method according to an aspect of the present disclosure includes: calculating a probability density distribution of a work time that is at least part of a setup time, based on production performance data read from storage, the setup time being time taken for a setup work that is performed between lots; determining whether the work time is anormal, based on the probability density distribution; and outputting a result of the determining.

With this, it is possible to accurately determine whether a work time is anormal, using the probability density distribution of the work time that is at least part of the setup time. It is thus possible to accurately identify the setup time that includes an anormal work time. Stated differently, it is possible to determine whether the setup time is anormal.

Also, for example, the setup time may include: a first work time taken for post-processing of a first lot; a second work time taken for preparation to manufacture a second lot that is manufactured subsequently to the first lot; and a third work time that is between the first work time and the second work time, the calculating may include calculating a probability density distribution of each of the first work time, the second work time, and the third work time, and the determining may include: calculating the first work time, the second work time, and the third work time, based on a work condition of the setup time; and determining whether each of the first work time, the second work time, and the third work time calculated is anormal.

With this, it is possible to analyze the setup time that is divided into at least three work times. This achieves more accurate determination of whether the setup time is anormal. It is also possible to accurately identify the cause of an anomaly when the setup time is determined to be anormal, which can contribute, for example, to the improvement of setup works.

Also, for example, the work condition may be defined by a plurality of items including the first lot, the second lot, equipment that manufactures the first lot and the second lot, and a worker who conducts the setup work.

With this, the work condition includes information about the first lot and the second lot manufactured before and after the setup work, respectively, and information about the worker who conducts the setup work. As such, it is possible to improve the estimation accuracy of probability density distributions. This consequently improves the accuracy of determining whether the setup time is anormal.

Also, for example, the calculating may further include calculating a probability density distribution of a process lead time, based on the production performance data, the process lead time being time including the setup time and a manufacturing time taken to manufacture one of the lots that is manufactured immediately after the setup time, and the determining may further include determining whether the process lead time is anormal, based on the probability density distribution of the process lead time.

With this, anomaly determination is performed on the process lead time that is directly linked to the improvement of the productivity. This thus efficiently improves the productivity by taking countermeasures for reducing the process lead time that is determined to be anormal.

Also, for example, the determining may further include: calculating a degree of impact of the work time on an anomaly of the process lead time, based on the probability density distribution of each of the process lead time and the work time, when the process lead time is determined to be anormal; and determining whether the work time is anormal, based on the degree of impact calculated.

With this, it is possible to identify the cause of the anomaly by calculating the degrees of impact of the respective times included in the process lead time. The identification of the cause of the anomaly enables effective countermeasures to be taken to improve the productivity.

Also, for example, the manufacturing time may include: an operating time of equipment that manufactures the lots; a stoppage loss time caused by stoppage of the equipment; and a defect loss time caused by the equipment having manufactured defective products, the calculating may further include calculating a probability density distribution of each of the operating time, the stoppage loss time, and the defect loss time, based on the production performance data, and the determining may further include: calculating a degree of impact of each of the operating time, the stoppage loss time, and the defect loss time on an anomaly of the process lead time, based on the probability density distribution of each of the process lead time, the operating time, the stoppage loss time, and the defect loss time, when the process lead time is determined to be anormal; and determining whether each of the operating time, the stoppage loss time, and the defect loss time is anormal, based on the degrees of impact calculated.

With this, it is possible to identify, as the cause of the anomaly, not only the setup time, but also, for example, the performance loss time, the stoppage loss time, and the defect loss time. This thus enables more effective countermeasures to be taken for the anomaly.

Also, for example, in the calculating, the probability density distribution of the process lead time may be calculated by obtaining a sum of (i) a distribution obtained by multiplying, by a total number of conforming products, a probability density distribution of a takt time taken to manufacture one conforming product, (ii) the probability density distribution of the setup time, and (iii) a predetermined correction parameter.

With this, it is possible to accurately calculate the probability density distribution of the process lead time.

Also, the program according to an aspect of the present disclosure is a program for causing a computer to execute the information processing method according to the foregoing aspects.

With this, it is possible to accurately identify an anomaly in the setup time, as with the foregoing information processing method.

The information processing device according to an aspect of the present disclosure includes: a calculator that calculates a probability density distribution of a work time that is at least part of a setup time, based on production performance data read from storage, the setup time being time taken for a setup work that is performed between lots; a determiner that determines whether the work time is anormal, based on the probability density distribution; and an outputter that outputs a determination result of the determiner.

With this, it is possible to accurately identify an anomaly in the setup time, as with the foregoing information processing method.

Hereinafter, a certain exemplary embodiment is described in greater detail with reference to the accompanying Drawings.

The exemplary embodiment described below shows a general or specific example. The numerical values, shapes, materials, elements, the arrangement and connection of the elements, steps, the processing order of the steps etc. shown in the following exemplary embodiment are mere examples, and therefore do not limit the scope of the present disclosure. Therefore, among the elements in the following exemplary embodiment, those not recited in any one of the independent claims are described as optional elements.

The drawings are schematic views, and are not always strictly drawn. Accordingly, for example, the drawings are not always drawn to scale. In the drawings, the same reference signs are given to substantially the same configurations, and duplication of descriptions of the substantially the same configurations will be omitted.

Also, in the present specification, ordinal numbers such as “first” and “second” do not mean the number or order of elements unless otherwise specified, but are used to distinguish between elements of the same type and avoid confusion.

In the present specification, terms “production” and “manufacture/manufacturing” are used to express substantially the same meaning.

Also, in the present specification, “lot” means the production unit of products, and is constituted by a predetermined number of products that are produced under the same production condition. To “manufacture a lot” means to manufacture a predetermined number of products that constitute the lot. The predetermined number may be one, or may be more than one. The product type of the predetermined number of products that constitute the lot is the same (only one product type). When a plurality of lots are successively manufactured in a single piece of equipment, at least one of the product type of the lots or the number of products manufactured in the lots may either be the same or different.

### Embodiment

### [1. Loss Time]

First, a loss time will be described that can be the cause of a decrease in the productivity and that should be identified by the information processing device or the information processing method according to the present embodiment. The loss time is the time that is originally unnecessary and an additional time taken longer than usual due to some cause or other. The loss time is included in a process lead time.

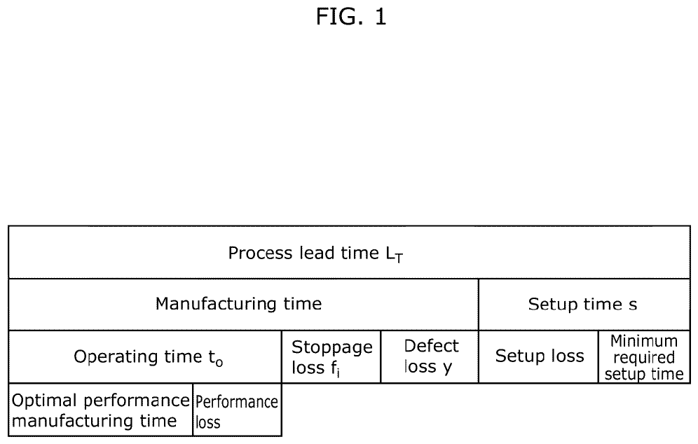

FIG. 1 is a diagram showing the details of process lead time L_{T}. Process lead time L_{T} shown in FIG. 1 is the time taken from the start to the completion of the target process. Process lead time L_{T} includes not only the time during which the equipment that conducts the target process is actually in operation, but also, for example, the time during which the equipment is stopped due to an error or other cause, and the time taken for the preparation to bring the equipment into operation.

More specifically, as shown in FIG. 1, process lead time L_{T} includes a manufacturing time and setup time s. Even more specifically, process lead time L_{T} is a total time of the manufacturing time and setup time s.

The manufacturing time includes operating time t₀, stoppage loss time fᵢ, and defect loss time y. More specifically, the manufacturing time is a total time of operating time t₀, stoppage loss time fᵢ, and defect loss time y.

Operating time t₀ is the time during which the equipment that manufactures the lot is in operation. More specifically, operating time t₀ is the time during which the equipment is manufacturing conforming products. Operating time t₀ is a total time of an optimal performance manufacturing time and a performance loss time. The optimal performance manufacturing time is the time during which the equipment is able to manufacture conforming products with its optimal performance. The performance loss time is the loss time caused by a decrease in the performance of the equipment, that is, an additional time taken due to a decrease in the performance. The performance loss time is caused, for example, by a decrease in the production speed of the equipment.

Stoppage loss time fᵢ is the loss time caused by stopping the equipment, that is, an additional time taken due to the stoppage of the equipment. Stoppage loss time fᵢ is, for example, the time from when the equipment is stopped to when the equipment is restored. The index “i” indicates an identification number that is defined for each cause of stoppage. When the equipment is stopped plurality of times due to a plurality of causes, a total time of stoppage loss times fᵢ for the respective causes of stoppage is included in the manufacturing time.

Defect loss time y is the loss time caused by the equipment having manufactured defective products, that is, an additional time taken to manufacture defective products. Defect loss time y is, for example, the manufacturing time of defective products.

Setup time s is the time taken for a setup work between lots. Setup time s includes a setup loss time and a minimum required setup time. More specifically, setup time s is a total time of the minimum required setup time and the setup loss time.

The minimum required setup time is the minimum time required for the setup work. A setup work is required even in the case where the product type and the number of products manufactured are the same between the preceding lot and the subsequent lot of such setup work.

The setup loss time is an additional time taken during the setup work due to some cause or other, that is, the loss time relating to the setup work. The setup loss time is caused, for example, by a worker having insufficient skills, incorrect order of works, incorrect details of works, and so forth.

Taking as an example process lead time L_{T} of the forming process of resin products, the performance loss time, stoppage loss time fᵢ, defect loss time y, and the setup loss time occur, for example, in the following situations: the performance loss time occurs when products are manufactured at a slower speed than the optimal speed to check the conditions of the equipment immediately after the mold attachment; stoppage loss time fᵢ occurs due to the faulty of resin projection that is caused by insufficient maintenance of the equipment; defect loss time y occurs due to an increase in the number of defective products that is caused by the faulty of mold attachment; and the setup loss time occurs due to a large number of works for product changeover and thus a longer time spent on the setup works than usual.

Note that the causes of the foregoing loss times are mere examples. Also note that the target process is not limited to the forming process, and thus may be the application process to metal plates, the component mounting process, and so forth.

As described above, the performance loss time, stoppage loss time fᵢ, defect loss time y, and the setup loss time are four loss times that can be the cause of an increase in process lead time L_{T} and a decrease in the productivity. The information processing method according to the present embodiment detects an anomaly in process lead time L_{T} (i.e., decrease in the productivity), and identifies the cause of the detected anomaly among the four loss times. Stated differently, candidate causes of the anomaly include not only the performance loss time, stoppage loss time fᵢ, and defect loss time y included in the manufacturing time, but also the setup loss time. For this reason, the information processing method according to the present embodiment is capable of determining not only whether a manufacturing time is anormal, but also whether a setup time is anormal. This enables effective countermeasures to be taken such as an improvement in setup works, thereby contributing to improved productivity.

### [2. Setup Time]

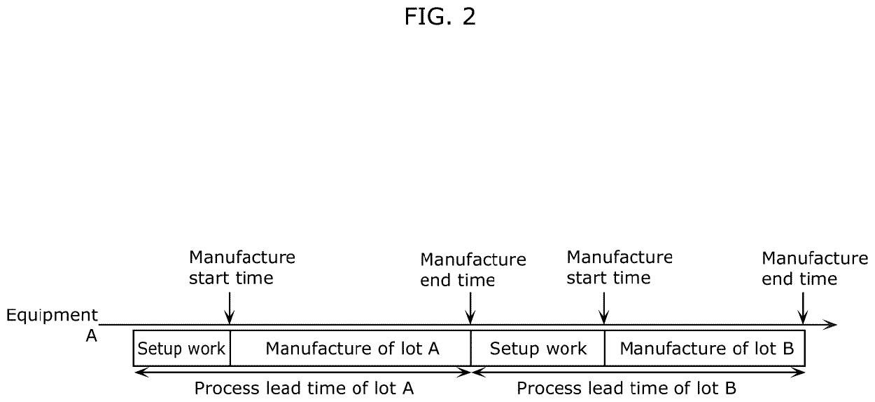

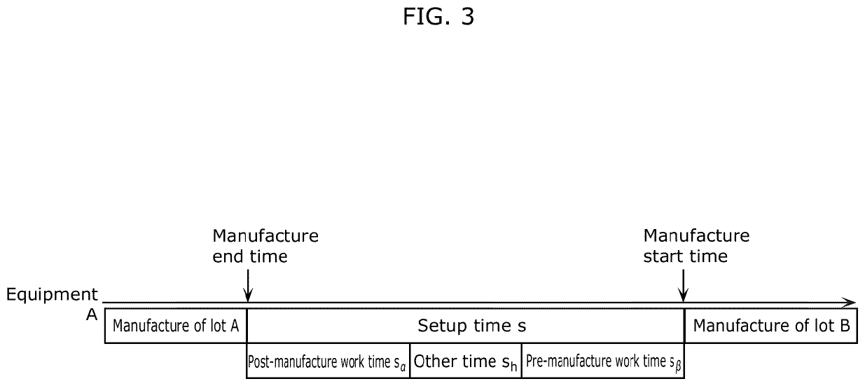

With reference to FIG. 2 and FIG. 3, the following describes the details of the setup time.

FIG. 2 is a diagram showing the relation between manufacturing times and setup works required to manufacture a plurality of lots. FIG. 3 is a diagram showing the details of setup time s.

As shown in FIG. 2, when lot A and lot B are successively manufactured in stated order, a worker performs setup works at the timing that is before the manufacture of lot A and at the timing that is after the manufacture of lot A and before the manufacture of lot B. Setup time s is the time from the time at which the manufacture of the previous lot ends to the time at which the manufacture of the subsequent lot starts.

Note that lot A is an example of a first lot, and lot B is an example of a second lot. The second lot is the lot that is manufactured subsequently to the first lot in the same equipment. No other lots are manufactured by the same equipment between the manufacture of the first lot and the manufacture of the second lot. In the following description, the first lot can be also referred to as “previous lot” and the second lot can be also referred to as “subsequent lot”. The subsequent lot is the target lot that is manufactured during process lead time L_{T}. In the present embodiment, setup time s is included in process lead time L_{T} of the target lot (subsequent lot).

In the present embodiment, setup time s includes a plurality of work times sⱼ. The plurality of work times sⱼ are elements (setup elements) into which setup time s is divided. More specifically, as shown in FIG. 3, setup time s is a total time of post-manufacture work time s_{α}, pre-manufacture work time s_{β}, and other time sₕ. Note that index “j” means any one of α, β, or h.

Post-manufacture work time s_{α} is a first work time taken for the post-processing of the previous lot. The post-processing is, for example, processing of organizing the materials and/or components used to manufacture the previous lot (detachment from the equipment). Post-manufacture work time s_{α} mainly depends on the product type and the number of products manufactured in the previous lot.

Pre-manufacture work time s_{β} is a second work time taken for the preparation to manufacture the subsequent lot (pre-processing). The preparation to manufacture the subsequent lot (pre-processing) is, for example, the attachment of the materials and/or components used to manufacture the subsequent lot, the settings of parameters for controlling the equipment, and so forth. Pre-manufacture work time s_{β} mainly depends on the product type and the number of products manufactured in the subsequent lot.

Other time sₕ is a third work time between post-manufacture work time s_{α} and pre-manufacture work time s_{β}. Other time sₕ is the time taken for works that belong to neither the post-processing of the previous lot nor the preparation to manufacture the subsequent lot.

In general, a manufacturing workplace such as a factory has a large number of equipment, where a large number of workers are conducting works. Also, the timings and work times of the workers performing setup works are usually different. For this reason, it is not easy to measure post-manufacture work time s_{α}, pre-manufacture work time s_{β}, and other time sₕ one by one for all pieces of equipment. In view of this, the information processing method or the information processing device according to the present embodiment calculates work times sⱼ, on the basis of the work condition of a setup work.

### [3. Overview of Production Anomaly Estimation Device and Utilization Data]

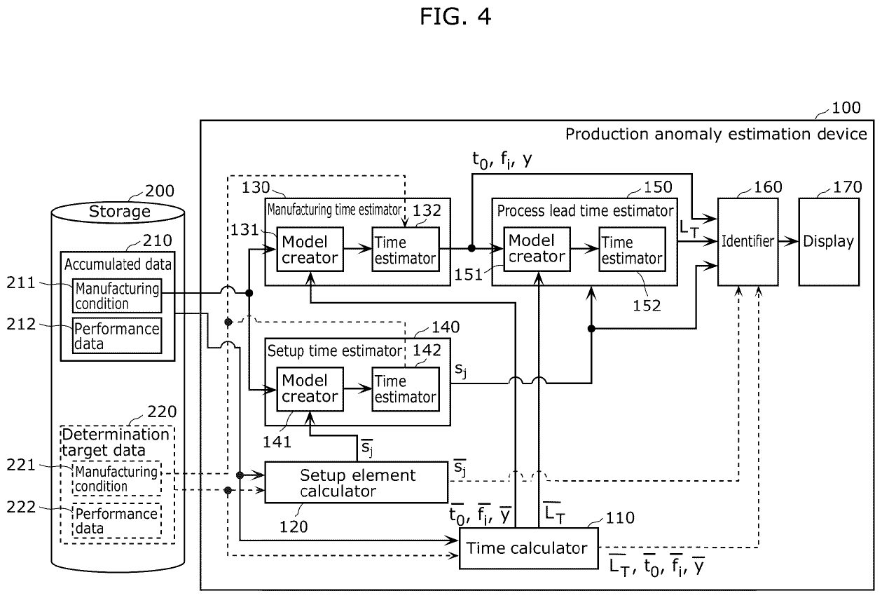

With reference to FIG. 4, the following describes an overview of the production anomaly estimation device, which is an example of the information processing device according to the present embodiment, and data to be utilized by the production anomaly estimation device.

FIG. 4 is a block diagram showing the functional configuration of production anomaly estimation device 100 according to the present embodiment. Production anomaly estimation device 100 shown in FIG. 4 is a computer device that executes the information processing method according to the present embodiment. Production anomaly estimation device 100 may be a single computer device or may be a plurality of computer devices that are connected via a network. Production anomaly estimation device 100 includes, for example, a nonvolatile memory that stores a program, a volatile memory serving as a temporary storage region for executing the program, an input/output port, and a processor that executes the program. The processor executes the processes of the functional processing units included in production anomaly estimation device 100 in conjunction with, for example, the memory.

Production anomaly estimation device 100 reads necessary data from storage 200, and executes the processes, using the data read out. In the present embodiment, storage 200 is a storage device that is provided separately from production anomaly estimation device 100 and connected to production anomaly estimation device 100 by wire or wirelessly to be able to perform communication. Examples of storage 200 include a hard disk drive (HDD) and a sloid state drive (SDD). Note that storage 200 may be included in production anomaly estimation device 100.

Storage 200 stores accumulated data 210 and determination target data 220.

Accumulated data 210 is data relating to the past production and data obtained on the basis of manufacture log data. Accumulated data 210 is utilized for the creation of estimation models that are used to estimate operating time t₀, stoppage loss time fᵢ, defect loss time y, and setup time s (work times sⱼ). Accumulated data 210 includes manufacturing condition 211 and performance data 212.

Manufacturing condition 211 is defined on a process-by-process basis over a plurality of items. Examples of the plurality of items include the product type and the number of products manufactured in a lot, the equipment that manufactures the lot, and a worker who performs a setup work included in the process. The work condition of the setup work is identifiable on the basis of manufacturing condition 211.

Performance data 212 is production performance data indicating the production performance results of a plurality of lots in the past. More specifically, performance data 212 includes manufacture start times, manufacture end times, the history of stopping the equipment, the ratios of defective products, and so forth. The history of stopping the equipment includes, for example, the equipment subjected to stoppage, the stoppage time at which the equipment is stopped, and the restoration time at which the equipment is restored.

Determination target data 220 is data to be subjected to anomaly determination performed by production anomaly estimation device 100. Determination target data 220 includes manufacturing condition 221 and performance data 222. Specific elements of each of manufacturing condition 221 and performance data 222 are the same as those of manufacturing condition 211 and performance data 212 of accumulated data 210. When only one process is subjected to anomaly determination, for example, the information of the immediately previous lot (previous lot) is used to estimate setup time s. For this reason, manufacturing condition 221 and performance data 222 include the data of the target one process and the data of the immediately previous process.

### [4. Functional Configuration of Production Anomaly Estimation Device]

With reference to FIG. 4, the following describes the functional configuration of production anomaly estimation device 100.

As shown in FIG. 4, production anomaly estimation device 100 includes time calculator 110, setup element calculator 120, manufacturing time estimator 130, setup time estimator 140, process lead time estimator 150, identifier 160, and display 170. In the following, specific processes performed by these functional elements will be described one by one.

### [4-1. Time Calculator]

Time calculator 110 calculates process lead time L_{T}, operating time t₀, stoppage loss time fᵢ, and defect loss time y. Process lead time L_{T} is obtained by subtracting the manufacture end time of the previous lot from the manufacture end time of the subsequent lot as shown in FIG. 2.

Operating time t₀ is obtained by subtracting stoppage loss time fᵢ and defect loss time y from the manufacturing time as shown in FIG. 1. The manufacturing time is obtained by subtracting the manufacture start time of the subsequent lot from the manufacture end time of the subsequent lot as shown in FIG. 2.

Stoppage loss time fᵢ is calculated on the basis of the stoppage time and the restoration time included in the range from the manufacture start time of the subsequent lot to the manufacture end time of the subsequent lot. The stoppage time of one stoppage is the time obtained by subtracting the stoppage time from the restoration time. When a plurality of stoppage times and a plurality of restoration times are included, that is, when a plurality of stoppages occurred, stoppage loss time fᵢ is obtained by totaling the stoppage times of the respective stoppages.

Defect loss time y is obtained by multiplying the time that is obtained by subtracting stoppage loss time fᵢ from the manufacturing time (manufacturing time−(subtracted by) stoppage loss time fᵢ) by the ratio of the defective products. The ratio of the detective products is the proportion of the number of defective products in the number of products manufactured in the subsequent lot. The number of products manufactured is the sum of the conforming products and the defective products.

Time calculator 110 calculates process lead time L_{T}, operating time t₀, stoppage loss time fᵢ, and defect loss time y on a process-by-process basis, on the basis of each of accumulated data 210 and determination target data 220. The calculated times are actual measured values obtained from performance data 212 and 222.

The actual measured values obtained from performance data 212 of accumulated data 210 are utilized for the creation of estimation models. The actual measured values of operating time t₀, stoppage loss time fᵢ, and defect loss time y are outputted to model creator 131 of manufacturing time estimator 130. The actual measured values of process lead time L_{T} are outputted to model creator 151 of process lead time estimator 150.

The actual measured values obtained from performance data 222 of determination target data 220 are utilized for anomaly determination. The actual measured values of process lead time L_{T}, operating time t₀, stoppage loss time fᵢ, and defect loss time y are outputted to identifier 160.

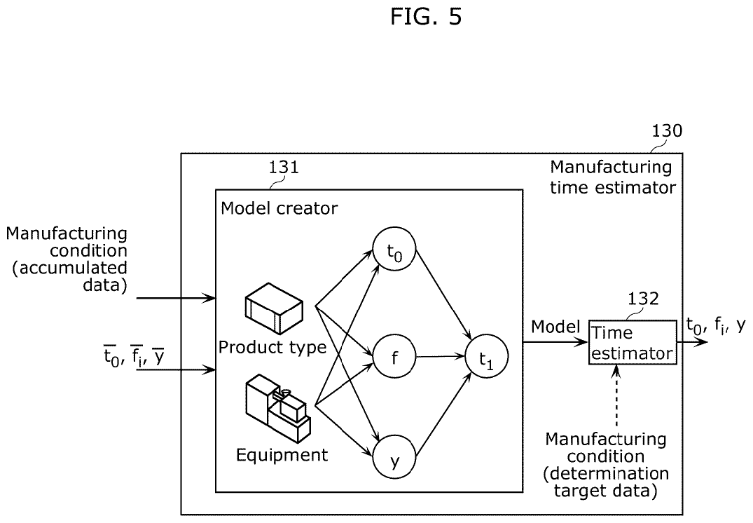

Note that, in FIG. 4, symbols L_{T}, t₀, fᵢ, y, and sⱼ are overlined ( ) to represent the actual measured values of the respective times. Symbols without overlines ( ) represent the estimates of the respective times. Also note that, in FIG. 4, the flow of accumulated data 210 is indicated by a solid line arrow, and the flow of determination target data 220 is indicated by a broken line arrow. These indications are applicable also in FIG. 5 through FIG. 7 to be described later.

### [4-2. Setup Element Calculator]

Setup element calculator 120 calculates a plurality of work times sⱼ included in setup time s (i.e., setup elements). More specifically, setup element calculator 120 calculates post-manufacture work time s_{α}, pre-manufacture work time s_{β}, and other time sₕ on a process-by-process basis. Note that setup time s is obtained by subtracting the manufacture end time of the previous lot from the manufacture start time of the subsequent lot as shown in FIG. 2.

Post-manufacture work time s_{α} includes time element α_{y} that depends on the number of products manufactured and time element α_{z} that is independent of the number of products manufactured. Similarly, post-manufacture work time s_{β} includes time element β_{y} that depends on the number of products manufactured and time element β_{z} that is independent of the number of products manufactured. Assuming that the number of products manufactured in the previous lot is “n” and the number of products manufactured in the subsequent lot is “m”, post-manufacture work time s_{α} and pre-manufacture work time s_{β} are represented by Equations (1) and (2) below.

s_{α}=n×α_{y}+α_{z} (1)

s_{β}=m×β_{y}+β_{z} (2)

Thus, post-manufacture work time s_{α} and pre-manufacture work time s_{β} are calculated by obtaining α_{y}, α_{z}, β_{y}, and β_{z}. Note that other time sₕ is independent of the number of products manufactured.

When performance data 212 of accumulated data 210 includes four pieces of performance data of work conditions in which only the numbers of products manufactured “n” and “m” are different (the other items are the same), α_{y}, α_{z}, β_{y}, and β_{z} can be calculated, using Equation (3) below. Performance data is represented by a combination of (n, m, s). Note that the other items are, more specifically, the product type of the previous lot, the product type of the subsequent lot, the equipment, and a worker.

s=s_{α}+s_{β}+sₕ=n×α_{y}+α_{z}+m×β_{y}+β_{z}+sₕ (3)

Assume, for example, that the four pieces of performance data are (n₁, m₁, s₁), (n₂, m₂, s₂), (n₃, m₃, s₃), and (n₄, m₄, s₄). All of these values are known values. When each of these four pieces of performance data is assigned to Equation (3), Equations (4) through (7) below are obtained.

s₁=n₁×α_{y}+α_{z}+m₁×β_{y}+β_{z}+sₕ (4)

s₂=n₂×α_{y}+α_{z}+m₂×β_{y}+β_{z}+sₕ (5)

s₃=n₃×α_{y}+α_{z}+m₃×β_{y}+β_{z}+sₕ (6)

s₄=n₄×α_{y}+α_{z}+m₄×β_{y}+β_{z}+sₕ (7)

The simultaneous equations of Equations (4) through (7) are solved to give α_{y} and β_{y} as shown in Equations (8) and (9) below.

$$\begin{matrix}[ Math . 1 ] & \\ {α}_{y} = \frac{( {m}_{3} - {m}_{4} ) ( {s}_{1} - {s}_{2} ) - ( {m}_{1} - {m}_{2} ) ( {s}_{3} - {s}_{4} )}{( {n}_{1} - {n}_{2} ) ( {m}_{3} - {m}_{4} ) - ( {n}_{3} - {n}_{4} ) ( {m}_{1} - {m}_{2} )} & ( 8 )\end{matrix}$$

$${β}_{y} = \frac{{s}_{1} - {s}_{2} - ( {n}_{1} - {n}_{2} ) {α}_{y}}{{m}_{1} - {m}_{2}} \qquad ( 9 )$$

α_{z}, β_{z}, and sₕ are obtained, using Equations (10) and (11) below.

τ=t−(n×α_{y}+m×β_{y}) (10)

α_{z}+β_{z}+sₕ=τ (11)

In the following description, α_{z} and β_{z} under predetermined production condition P are described as α_{z}^{P} and β_{z}^{P}, respectively. For simplification, assume the case where only one production condition P is present (which is more specifically the case where the same worker manufactures products of the same product type in the same equipment). In this case, Equation (11) described above is represented as Equation (12) below.

α_{z}^{P}+β_{z}^{P}+sₕ=τ (12)

However, α_{z}, β_{z}, and sₕ cannot be obtained only from this equation. In view of this, Equation (12) is to be represented by an equation, using a matrix. More specifically, by describing D=(1 1 1), w=(a_{z} β_{z} sₕ)^{T}, and b=(τ), Equation (12) is represented as shown in Equation (13) below. Note that the index “T” represents transposed matrix.

Dw=b (13)

In the present embodiment, using L₂ least norm point as the solution, setup element calculator 120 determines “w” as shown in Equation (14).

w=D^{T}(DD^{T})⁻¹b (14)

Since only one work condition P is present, “w” can be obtained as shown in Equation (15).

$$\begin{matrix}[ Math . 2 ] & \\ w = {( \begin{matrix}1 & 1 & 1\end{matrix} )}^{T} \frac{1}{3} τ = ( \begin{matrix}\frac{1}{3} τ & \frac{1}{3} τ & \frac{1}{3} τ\end{matrix} ) & ( 15 )\end{matrix}$$

When production condition Q is included in addition to production condition P, four variations of work conditions of the setup works are present, that is, P→P, P→Q, Q→P, and Q→Q. Note that the starting point of “→” indicates the production condition of the previous lot, and the endpoint of “→” indicates the production condition of the subsequent lot. Stated differently, “P→P” and “Q→Q” mean that there is no change in the production conditions between the lots.

Equations (16) through (19) are obtained from Equation (11), on the basis of the performance data of the four variations of work conditions.

α_{z}^{P}+β_{z}^{P}+sₕ=τ₁ (16)

α_{z}^{P}+β_{z}^{Q}+sₕ=τ₂ (17)

α_{z}^{Q}+β_{z}^{P}+sₕ=τ₃ (18)

α_{z}^{Q}+β_{z}^{Q}+sₕ=τ₄ (19)

By organizing Equations (16) through (19), Equations (20) through (22) below are obtained.

α_{z}^{P}+β_{z}^{Q}+sₕ=τ₂ (20)

β_{z}^{P}−β_{z}^{Q}=τ₃−τ₄ (21)

α_{z}^{Q}+β_{z}^{Q}+sₕ=τ₄ (22)

As in the case where only one production condition is present, Equations (20) through (22) are represented by equations, using the matrix of Equation (13). In this case, “D”, “w”, and “b” are represented as shown in Equations (23) through (25) below.

$$\begin{matrix}[ Math . 3 ] & \\ D = ( \begin{matrix}1 & 0 & 0 & 1 & 1 \\ 0 & 1 & 0 & - 1 & 0 \\ 0 & 0 & 1 & 1 & 1\end{matrix} ) & ( 23 )\end{matrix}$$

$$w = {( \begin{matrix}{α}_{z}^{P} & {β}_{z}^{P} & {α}_{z}^{Q} & {β}_{z}^{Q} & {s}_{h}\end{matrix} )}^{T} \qquad ( 24 )$$

$$b = ( \begin{matrix}{τ}_{2} & {τ}_{3} - {τ}_{4} & {τ}_{4}\end{matrix} ) \qquad ( 25 )$$

From this, it is possible to obtain “w” on the basis of Equation (14), as in the case where only one condition is present. Even in the case where three or more conditions are present, α_{z}, β_{z}, and sₕ can be calculated in the same manner.

Note that data obtained by the calculations are based on the plural pieces of performance data, and thus decreases in the amount than the original pieces performance data. For example, a single pair of α_{y} and β_{y} are obtained from the four pieces of performance data. The same is applicable to α_{z}, β_{z}, and sₕ. To increase the amount of data to be obtained by calculations, the combinations of the original pieces of performance data are simply required to be changed. An increased amount of data obtained by the calculations improves the accuracy of the estimation models, thereby enhancing the accuracy of anomaly determination.

Setup element calculator 120 calculates work times s_{α}, s_{β}, and sₕ on a process-by-process basis, on the basis of each of accumulated data 210 and determination target data 220. The calculated times are regarded as the actual measured values obtained from performance data 212 and 222.

The actual measured values obtained from performance data 212 of accumulated data 210 are utilized for the creation of the estimation models. The actual measured values of work times s_{α}, s_{β}, and sₕ are outputted to model creator 141 of setup time estimator 140.

The actual measured values obtained from performance data 222 of determination target data 220 are utilized for anomaly determination. The actual measured values of work times s_{α}, s_{β}, and sₕ are outputted to identifier 160.

### [4-3. Manufacturing Time Estimator]

Manufacturing time estimator 130 calculates the probability density distributions of operating time t₀, stoppage loss time fᵢ, and defect loss time y, on the basis of manufacturing condition 211 and performance data 212 read from storage 200. As shown in FIG. 4 and FIG. 5, manufacturing time estimator 130 includes model creator 131 and time estimator 132. FIG. 5 is a diagram for describing the process performed by manufacturing time estimator 130.

Model creator 131 creates the estimation models of the manufacturing time on the basis of manufacturing condition 211 of accumulated data 210, and the actual measured values of operating time t₀, stoppage loss time fᵢ, and defect loss time y calculated by time calculator 110 on the basis of accumulated data 210. For example, model creator 131 performs evaluation, using effective takt time t₁ that is the time required to manufacture one conforming product. The method disclosed in PTL 2, for example, can be used to create the estimation model of effective takt time t₁.

More specifically, model creator 131 creates the estimation models of operating time t₀, stoppage loss time fᵢ, and defect loss time y, on the basis of the production condition that includes the product type and the equipment of the subsequent lot, and the actual measured values of operating time t₀, stoppage loss time fᵢ, and defect loss time y. The estimation models are probability density distributions of expected performance values (respective target times) under the production condition (more specifically, the product type and the equipment), and are defined by parameters of the probability density distributions.

Model creator 131 estimates the parameters of the probability density distributions on the basis of, for example, Bayesian estimation. When a probability density distribution is a normal distribution, for example, the parameters of such probability density distribution are mean μ and standard deviation σ (or variance σ²). In Bayesian estimation, parameters such as mean μ and standard deviation σ are also estimated as a possible probability distribution of the parameter values (posterior probability distribution). The estimation of a probability distribution of the parameters based on Bayesian estimation can be performed, using a sampling method such as Markov chain Monte Carlo Simulation (MCMC) or variational estimation such as the VB-EM algorithm.

Note that the probability density distributions are a normal distribution, a logarithmic normal distribution, a zero-inflated exponential distribution, a gamma distribution, and so forth. An appropriate distribution is defined for each of operating time t₀, stoppage loss time fᵢ, and defect loss time y. For example, the probability density distribution of operating time t₀ is a logarithmic normal distribution. The probability density distribution of stoppage loss time fᵢ is a zero-inflated exponential distribution. The probability density distribution of defect loss time y is a gamma distribution. The probability density distribution of effective takt time t₁ is obtained by calculating the total sum of operating time t₀, stoppage loss time fᵢ, and defect loss time y.

Time estimator 132 enters manufacturing condition 221 of determination target data 220 to the estimation models created by model creator 131, thereby calculating the estimates of the manufacturing time. More specifically, time estimator 132 calculates the estimates of operating time t₀, stoppage loss time fᵢ, and defect loss time y. The calculated estimates are outputted to process lead time estimator 150 and identifier 160. The estimates of the respective times are represented by the probability density distributions under a predetermined manufacturing condition.

### [4-4. Setup Time Estimator]

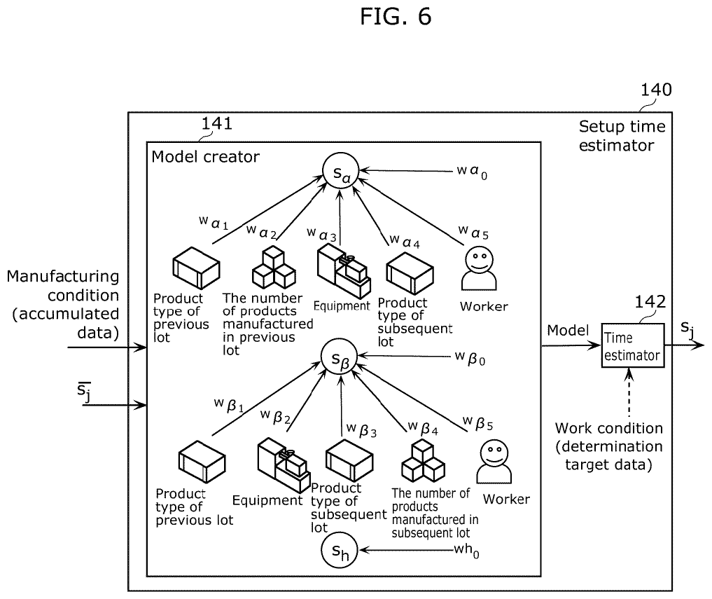

Setup time estimator 140 calculates the probability density distributions of setup time s, on the basis of manufacturing condition 211 and performance data 212 read from storage 200. More specifically, setup time estimator 140 calculates the probability density distribution of each work time sⱼ included in setup time s. As shown in FIG. 4 and FIG. 6, setup time estimator 140 includes model creator 141 and time estimator 142. FIG. 6 is a diagram for describing the process performed by setup time estimator 140.

Model creator 141 creates estimation models of work times sⱼ, on the basis of manufacturing condition 211 of accumulated data 210, and the actual measured values of work times sⱼ calculated by setup element calculator 120 on the basis of accumulated data 210. More specifically, model creator 141 determines the parameters of the probability density distributions of post-manufacture work time s_{α}, pre-manufacture work time s_{β}, and other time sₕ. Model creator 141 estimates the parameters of the respective probability density distributions on the basis of, for example, Bayesian estimation, as with model creator 131.

As shown in FIG. 6, in determining the parameters of the probability density distribution of post-manufacture work time s_{α}, a work condition including the following five items is used: the product type and the number of products manufactured in the previous lot; the equipment; the product type of the subsequent lot; and the worker. The work condition can be obtained on the basis of manufacturing condition 211 of accumulated data 210. Model creator 141 determines, as the parameters, weight coefficients w_{α1} through w_{α5} for the respective five items, and weight coefficient w_{α0} that is independent of the work condition. For example, the probability density distribution of the estimates of post-manufacture work time s_{α} is set to normal distribution N (μ, σ) of mean μ and standard deviation σ. In this case, μ and σ are represented by Equations (26) and (27) below.

μ=μ_{y}×(the number of products manufactured in the previous lot)+μ_{z}

μ_{y}=w_{μy1}×(equipment)+w_{μy2}×(product type of the previous lot)×(product type of the subsequent lot)+w_{μy3}×(product type of the previous lot)+w_{μy4}×(worker)

μ_{z}=w_{μz1}×(equipment)+w_{μz2}×(product type of the previous lot)×(product type of the subsequent lot)+w_{μz3}×(product type of the previous lot)+w_{μz4}×(worker) (26)

σ=σ_{y}×(the number of products manufactured in the previous lot)+σ_{z}

σ_{y}=w_{σy1}×(equipment)+w_{σy2}×(product type of the previous lot)×(product type of the subsequent lot)+w_{σy3}×(product type of the previous lot)+w_{σy4}×(worker)

σ_{z}=w_{σz1}×(equipment)+w_{σz2}×(product type of the previous lot)×(product type of the subsequent lot)+w_{σz3}×(product type of the previous lot)+w_{σz4}×(worker) (27)

w_{μy1}, w_{μy2}, w_{μy3}, w_{μy4}, w_{μz1}, w_{μz2}, w_{μz3}, w_{μz4}, w_{σy1}, w_{σy2}, w_{σy3}, w_{σy4}, w_{σz1}, w_{σz2}, w_{σz3}, and w_{σz4} in Equations (26) and (27) above correspond to the parameters of the probability density distribution, on the basis of which w_{α1} through w_{α5}, and w_{α0} shown in FIG. 6 can be determined. Model creator 141 calculates the parameters on the basis of the actual measured values of post-manufacture work time s_{α} calculated by setup element calculator 120 on the basis of accumulated data 210, and the work condition included in manufacturing condition 211.

The parameters of the probability density distribution of pre-manufacture work time s_{β} can be calculated in the same manner as post-manufacture work time s_{α}. More specifically, in Equations (26) and (27), the number of products manufactured in the subsequent lot is simply required to be used instead of the number of products manufactured in the previous lot. Also, the product type of the subsequent lot is simply required to be used instead of the product type of the previous lot relating to w_{μy3}, w_{μz3}, w_{σy3}, and w_{σz3} in Equations (26) and (27).

Also, the estimation model of other time sₕ is independent of the work condition, and thus is defined as a model into which no work condition is entered. The parameter of the probability density distribution of other time sₕ is, for example, only wₕ₀ shown in FIG. 6.

Time estimator 142 enters manufacturing condition 221 of determination target data 220 to the estimation models created by model creator 141, thereby calculating the estimates of work times sⱼ. More specifically, time estimator 142 calculates the estimates of pre-manufacture work time s_{α}, post-manufacture work time s_{β}, and other time sₕ. The calculated estimates are outputted to process lead time estimator 150 and identifier 160. The estimates of the respective work times are represented by the probability density distributions under a predetermined work condition.

### [4-5. Process Lead Time Estimator]

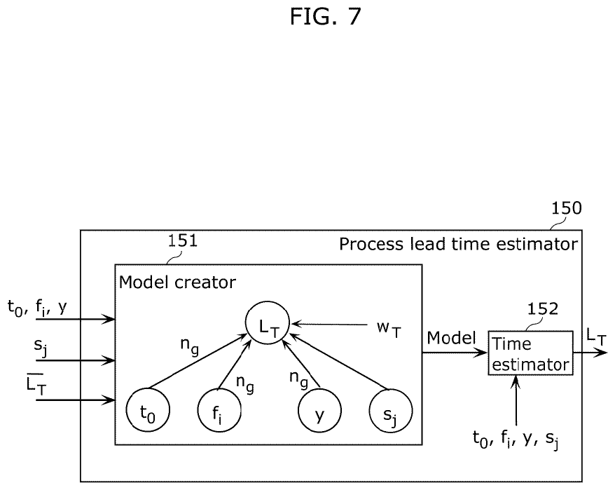

Process lead time estimator 150 calculates the probability density distribution of process lead time L_{T}, on the basis of manufacturing condition 211 and performance data 212 read from storage 200. As shown in FIG. 4 and FIG. 7, process lead time estimator 150 includes model creator 151 and time estimator 152. FIG. 7 is a diagram for describing the process performed by process lead time estimator 150.

Model creator 151 creates the estimation model of process lead time L_{T} on the basis of the estimates of operating time t₀, stoppage loss time fᵢ, and defect loss time y calculated by manufacturing time estimator 130, the setup times calculated by setup time estimator 140, and the actual measured values of process lead time L_{T} calculated by time calculator 110. More specifically, model creator 151 determines the parameters of probability density distribution of process lead time L_{T}. Model creator 151 estimates the parameters of the probability density distribution on the basis of, for example, Bayesian estimation, as with model creator 131.

Process lead time L_{T} is a total time of the manufacturing time and setup time s as shown in FIG. 1. Note that a difference is likely to occur between such total time and the actual process lead time L_{T} for some reason or other. In the present embodiment, correction parameter w_{T} that corresponds to such difference is set. With this, it is possible to represent the estimation model of process lead time L_{T} as a model that is obtained by combining the estimation models of the manufacturing time, the estimation models of setup time s, and correction parameter w_{T}.

As shown in FIG. 7, model creator 151 determines the parameters of the probability density distribution of process lead time L_{T}, using the estimates of operating time t₀, stoppage loss time fᵢ, and defect loss time y calculated by manufacturing time estimator 130, the estimates of setup time s calculated by setup time estimator 140 (more specifically, the estimates of work times sⱼ), and the actual measured value of process lead time L_{T}. More specifically, model creator 151 calculates correction parameter w_{T}. Manufacturing time estimator 130 calculates, as effective takt time, the estimates of operating time t₀, stoppage loss time fᵢ, and defect loss time y per one conforming product. As such, model creator 151 utilizes the values obtained by multiplying the estimates by the number of conforming products n_{g}. More specifically, model creator 151 adds the values obtained by multiplying the estimates of operating time t₀, stoppage loss time fᵢ, and defect loss time y by the number of conforming products n_{g} and the estimates of post-manufacture work time s_{α}, pre-manufacture work time s_{β}, and other time sₕ. Model creator 151 then subtracts the resulting value from the actual measured value of process lead time L_{T} to calculate correction parameter w_{T}.

Time estimator 152 enters the calculated estimates of the respective times to the estimation model created by model creator 151, thereby calculating the estimates of process lead time L_{T}. The calculated estimates are outputted to identifier 160. The estimates of process lead time L_{T} are represented by the probability density distribution in a predetermined manufacturing condition.

### [4-6. Identifier]

Identifier 160 determines whether process lead time L_{T} is anormal, and identifies the cause of an anomaly when identifier 160 determines that process lead time is anormal. More specifically, identifier 160 calculates the anomaly level of each of the actual measured values of process lead time L_{T}, on the basis of the estimates (probability density distribution) of process lead time L_{T} calculated by process lead time estimator 150. The anomaly level is an index indicating the level of difference between an actual measured value and an estimate.

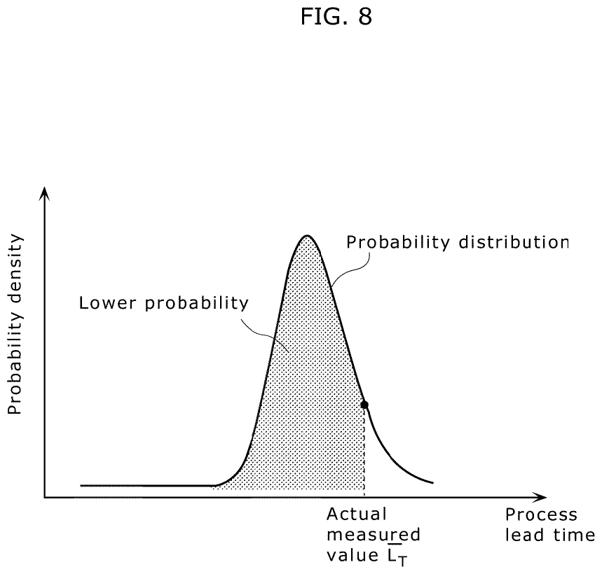

FIG. 8 is a diagram for explaining an anomaly level calculation method. In FIG. 8, the lateral axis indicates process lead time L_{T}, and the vertical axis indicates the probability density. The graph shown in FIG. 8 shows the probability density distribution of the estimates of process lead time L_{T} calculated by process lead time estimator 150.

In the present embodiment, identifier 160 calculates, as the anomaly level, the lower probability calculated on the basis of each of the actual measured values of process lead time L_{T}. The lower probability corresponds to the dot-shaded area in FIG. 8. The greater the lower probability, the more distant the actual measured value of process lead time L_{T} is from the estimates, that is, the anomaly level is higher. For example, identifier 160 calculates the anomaly level of each of the actual measured values (lower probability), and compares the calculated anomaly level with the threshold. When the calculated anomaly level is greater than or equal to the threshold, identifier 160 determines that process lead time L_{T} is anormal. Identifier 160 determines that process lead time L_{T} is normal (not anormal) when the calculated anomaly level is less than the threshold.

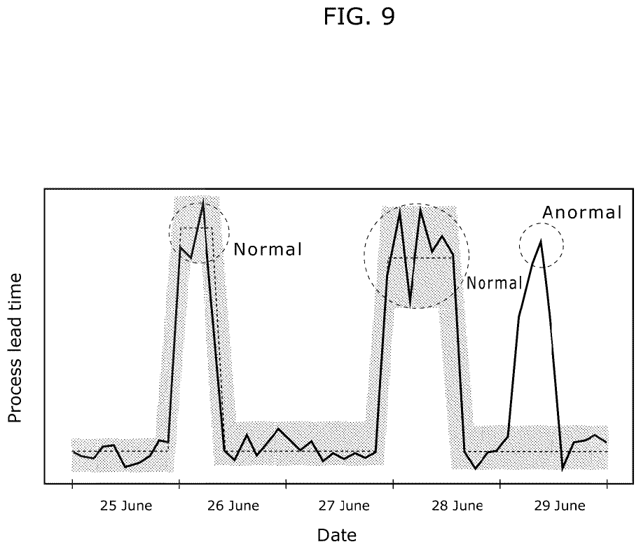

FIG. 9 is a diagram showing the occurrence of an anomaly in process lead time L_{T}. In FIG. 9, the lateral axis indicates dates (times) and the vertical axis indicates actual measured values of process lead time L_{T}. FIG. 9 also shows a predetermined range that is based on the estimates of process lead time L_{T} in the form of the doted shading. The predetermined range is a range that is determined on the basis of the probability density distributions that represent the estimates, and is a range indicating that process lead time L_{T} is not anormal. Stated differently, the predetermined range is a range of process lead time L_{T} when the lower probability determined on the basis of the probability density distribution is less than the threshold.

For this reason, a longer process lead time L_{T} can be within the normal range, depending on manufacturing condition, and thus is not necessarily determined to be anormal. In an example shown in FIG. 9, process lead time L_{T} is long on 26^{th}, 28^{th}, and 29^{th} of June. Of these, however, only 29^{th} of June is determined to be anormal. As described above, it is possible to accurately determine whether process lead time L_{T} is anormal compared to the case where only the duration of process lead time L_{T} is used for anomaly determination.

In the present embodiment, identifier 160 identifies the cause of an anomaly in process lead time L_{T} when process lead time L_{T} is determined to be anormal. More specifically, when process lead time L_{T} is determined to be anormal, identifier 160 calculates the degree of impact of each of operating time t₀, stoppage loss time fᵢ, and defect loss time y, and the degree of impact of each of work times sⱼ included in setup time s on the anomaly in process lead time L_{T}. More specifically, the degree of impact of each work time sⱼ is the degree of impact of each of post-manufacture work time s_{α}, pre-manufacture work time s_{β}, and other time sₕ.

A degree of impact is an index indicating the level of impact of each of the times on process lead time L_{T}. The time having a significant degree of impact is the cause of an anomaly in process lead time L_{T}. Stated differently, it is possible to determine whether each of the times is anormal, by determining whether the degree of impact of each of the times is significant.

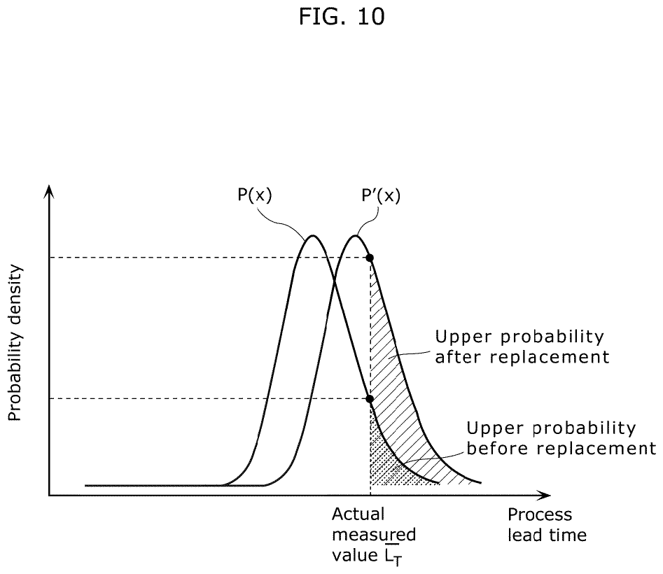

More specifically, the degree of impact is the amount of increase in the upper probability in the probability distribution of process lead time L_{T} in the case where the estimates of the respective times are replaced by the actual measured values. FIG. 10 is a diagram for describing a degree of impact calculation method. In FIG. 10, P(x) indicates the probability density distribution of process lead time L_{T} calculated by process lead time estimator 150, and P′(x) indicates the probability density distribution of process lead time L_{T} in the case where the estimates of the times subjected to determination are replaced by the actual measured values.

As is described above, process lead time L_{T} is represented by the sum of the respective times, and thus is represented as shown in Equation (28) below.

L_{T}=t₀+fᵢ+y+s_{α}+s_{β}+sₕ+w_{T} (28)

The terms in Equation (28) are all estimates. To calculate the degree of impact of post-manufacture work time s_{α}, for example, the estimate in Equation (28) is replaced by the actual measured value. Through this, Equation (29) is obtained. In Equation (29), the actual measured value is overlined ( ).

[Math. 4]

L′_{T}=t₀+fᵢ+y+s̅_̅{̅α̅}̅+s_{β}+sₕ+w_{T} (29)

When post-manufacture work time s_{α} is the cause of the anomaly, process lead time L′_{T} obtained by Equation (29) is less likely to be determined to be an anormal value. Stated differently, such replacement results in an increase in the upper probability in probability density distribution P′(x). As described above, the amount of increase in the upper probability and the degree of impact are correlated. In the present embodiment, identifier 160 calculates degree of impact I(q) of time q, on the basis of Equation (30) below.

[Math. 5]

I(q)=−log₂((p(L_{T}≥L̅_̅{̅T̅}̅))−{−log₂(p′(L_{T}≥L̅_̅{̅T̅}̅))} (30)

Note that in Equation (30),

[Math. 6]

p(L_{T}≥L̅_̅{̅T̅}̅)

is the upper probability before the estimate is replaced by the actual measured value, and

[Math. 7]

p′(L_{T}≥L̅_̅{̅T̅}̅)

is the upper probability after the estimate is replaced by the actual measured value. Note that the amount of decrease in the lower probability may be used instead of the amount of increase in the upper probability.

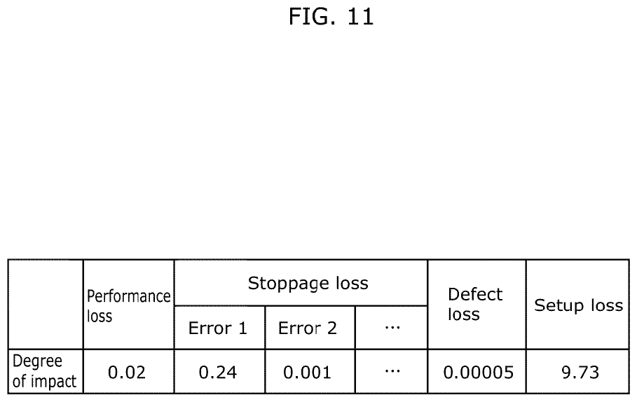

FIG. 11 is a diagram showing an example of the calculated degrees of impact. Note that FIG. 11 shows an example case where the degrees of impact of the entire setup time s are calculated, but the degree of impact may be calculated for each of the elements. An example of FIG. 11 shows that the setup loss included in setup time s has the greatest degree of impact. From this, it is possible to determine that the cause of the anomaly in process lead time L_{T} is the setup loss.

### [4-7. Display]

Display 170 is an example of an outputter that outputs the determination result of identifier 160. Non-limiting examples of display 170 include a liquid crystal display device and an organic electroluminescence (EL) display device.

More specifically, display 170 displays an image showing the determination result indicating whether process lead time L_{T} is anormal. When process lead time L_{T} is anormal, the image displayed by display 170 may include information that identifies the cause of the anomaly. Display 170 displays, for example, the table shown in FIG. 11.

Note that, instead of display 170, production anomaly estimation device 100 may include a sound outputter that outputs the determination result in the form of sound, and/or a communicator that transmits a signal including the determination result.

### [5. Operation]

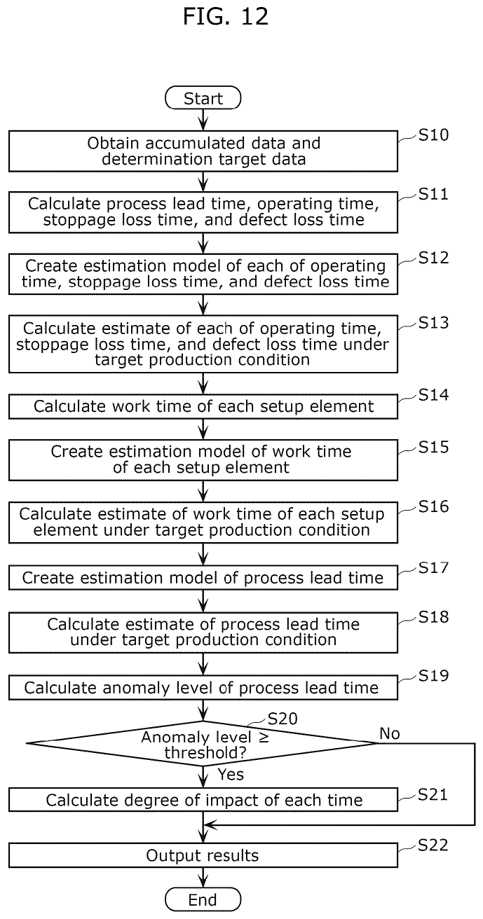

With reference to FIG. 12, the following describes an operation performed by production anomaly estimation device 100 according to the present embodiment (i.e., production anomaly estimation method, which is an example of the information processing method). FIG. 12 is a flowchart showing the operation performed by production anomaly estimation device 100 according to the present embodiment.

First, as shown in FIG. 12, production anomaly estimation device 100 obtains accumulated data 210 and determination target data 220 by reading out these pieces of data from storage 200 (S10). Next, time calculator 110 calculates process lead time L_{T}, operating time t₀, stoppage loss time fᵢ, and defect loss time y, on the basis of each of accumulated data 210 and determination target data 220 read out (S11).

Subsequently, model creator 131 of manufacturing time estimator 130 creates the estimation models of operating time t₀, stoppage loss time fᵢ, and defect loss time y, on the basis of manufacturing condition 211, and operating time t₀, stoppage loss time fᵢ, and defect loss time y calculated on the basis of accumulated data 210 (S12). Time estimator 132 of manufacturing time estimator 130 then calculates the probability density distributions that are the estimates of operating time t₀, stoppage loss time fᵢ, and defect loss time y, on the basis of manufacturing condition 221 of determination target data 220 (S13).

Subsequently, setup element calculator 120 calculates the work times of the respective setup elements (S14). More specifically, setup element calculator 120 calculates post-manufacture work time s_{α}, pre-manufacture work time s_{β}, and other time sₕ, on the basis of each of accumulated data 210 and determination target data 220 read out.

Subsequently, model creator 141 of setup time estimator 140 creates the estimation models of post-manufacture work time s_{α}, pre-manufacture work time s_{β}, and other time sₕ, on the basis of manufacturing condition 211, and post-manufacture work time s_{α}, pre-manufacture work time s_{β}, and other time sₕ calculated on the basis of accumulated data 210 (S15). Time estimator 142 of setup time estimator 140 then calculates the probability density distributions that are the estimates of post-manufacture work time s_{α}, pre-manufacture work time s_{β}, and other time sₕ on the basis of manufacturing condition 221 of determination target data 220 (S16).

Subsequently, model creator 151 of process lead time estimator 150 creates the estimation model of process lead time L_{T}, on the basis of the calculated estimates of operating time t₀, stoppage loss time fᵢ, and defect loss time y, the calculated estimates of post-manufacture work time s_{α}, pre-manufacture work time s_{β}, and other time sₕ, and the actual measured values of process lead time L_{T} (S17). Time estimator 152 of process lead time estimator 150 then calculates the probability density distribution that represents the estimates of process lead time L_{T}, on the basis of manufacturing condition 221 of determination target data 220 (S18).

Subsequently, identifier 160 calculates the anomaly level of each of the actual measured values, on the basis of the calculated probability density distribution and the actual measured value of process lead time L_{T} (S19). Identifier 160 then compares the calculated anomaly level with the threshold (S20).

When the anomaly level is greater than or equal to the threshold (Yes in S20), identifier 160 calculates the degrees of impact of operating time t₀, stoppage loss time fᵢ, and defect loss time y, and the degrees of impact of post-manufacture work time s_{α}, pre-manufacture work time s_{β}, and other time sₕ (S21). Identifier 160 identifies, as the cause of the anomaly in process lead time L_{T}, the time that corresponds to the greatest degree of impact among the calculated degrees of impact. Alternatively, identifier 160 may identify, as the cause of the anomaly, one or more of the times that correspond to one or more of degrees of impact that are greater than or equal to a predetermined threshold, among the calculated degrees of impact. Note that in the calculation of the degrees of impact, the degree of impact of any one of operating time t₀, stoppage loss time fᵢ, defect loss time y, post-manufacture loss time s_{α}, pre-manufacture work time s_{β}, or other time sₕ may not be calculated.

Subsequently, display 170 displays the result of anomaly determination and the result of cause identification (S22). When the anomaly level is less than the threshold, (No in S20), display 170 may not display the determination result.

Note that the processes shown in FIG. 12 are a mere example, and thus the processes may be performed in order that is different from the order shown in the drawing. For example, the process of calculating work times sⱼ (S14) may be performed prior to, for example, the process of calculating process lead time L_{T} (S11).

Also, some of the processes shown in the drawing may not be performed. For example, the process of calculating degrees of impact (S21) may not be performed. Also, the process of calculating process lead time L_{T}, operating time t₀, stoppage loss time fᵢ, and defect loss time y, the process of creating models, and the process of calculating estimates (S11 through S13) may not be performed. Also, the process of calculating the work times of the respective setup elements (S14) may not be performed. In this case, the estimation models of setup time s may be created in step S15, and the probability density distributions that are the estimates of setup time s may be calculated in step S16. Also, instead of determining whether process lead time L_{T} is anormal, an anomaly in work time sⱼ or setup time s may be determined.

### Other Embodiments

The information processing method and the information process device according to one or more aspects have been described above on the basis of the embodiment, but the present disclosure is not limited to such embodiment. The scope of the present disclosure also includes: an embodiment achieved by making various modifications to the embodiment that can be conceived by those skilled in the art without departing from the essence of the present disclosure; and other embodiment achieved by combining some of the elements of different embodiments.

For example, in the foregoing embodiment, production anomaly estimation device 100 determines whether setup time s that is divided into elements is anormal, but the present disclosure is not limited to this. Production anomaly estimation device 100 may determine whether setup time s is anormal. In this case, production anomaly estimation device 100 may not include setup element calculator 120.

Also, for example, production anomaly estimation device 100 may not determine whether process lead time L_{T} is anormal. Also, production anomaly estimation device 100 may not determine whether each of operating time t₀, stoppage loss time fᵢ, and defect loss time y is anormal. Stated differently, production anomaly estimation device 100 may only determine whether work time sⱼ that is at least part of the setup time is anormal. In this case, production anomaly estimation device 100 may not include time calculator 110, manufacturing time estimator 130, and process lead time estimator 150. For example, identifier 160 may determine whether the actual measured value (value that can be regarded as an actual measured value) calculated by setup element calculator 120 is anormal, on the basis of the estimate estimated by setup time estimator 140.

Also, setup time s may include only two work times of post-manufacture work time s_{α} and pre-manufacture work time s_{β}, on the assumption that setup time s does not include other time sₕ.

Also, the method for inter-device communication described in the foregoing embodiment is not limited to a specific method. When devices wirelessly communicate with each other, example wireless communication methods (communication standards) include near field communication such as ZigBee®, Bluetooth®, and wireless local area network (LAN). Alternatively, a wireless communication method (communication standards) may be communication that is performed via a wide area communication network such as the Internet. Also, devices may perform wired communication instead of wireless communication. More specifically, the wireless communication is, for example, communication utilizing power line communication (PLC) or a wired LAN.

Also, in the foregoing embodiment, a process performed by a specified processing unit may be performed by another processing unit. The processing order of a plurality of processes may also be changed, and a plurality of processes may be performed in parallel.

For example, the processes described in the forgoing embodiment may be performed by a single device (system) in a centralized manner, or by a plurality of devices in a distributed manner. Also, the processor that executes the foregoing program may be a single processor, or may be a plurality of processors. Stated differently, the processes may be performed in either a centralized or distributed manner.

All or some of the elements in the foregoing embodiment, such as a controller, may be configured in the form of an exclusive hardware product, or may be realized by executing a software program suitable for the element. Each of the elements may be realized by means of a program executing unit, such as a central processing unit (CPU) and a processor, reading and executing the software program recorded on a recording medium such as an HDD or a semiconductor memory.

Also, each of the elements such as a controller may be configured in the form of one or more electronic circuits. Each of such one or more electronic circuits may be a general-purpose circuit or may be an exclusive circuit.

Such one or more electronic circuits may include, for example, a semiconductor device, an integrated circuit (IC), or a large scale integration (LSI). The IC or LSI may be integrated into a single chip or in a plurality of chips. Although the electronic circuit is referred to here as IC or LSI, it may be referred to differently depending on the degree of integration. The IC or LSI can thus be referred to as a system LSI, a very large scale integration (VLSI), or an ultra large scale integration (ULSI). Also, a field programmable gate array (FPGA) that allows for programming after the manufacture of an LSI can also be used for the same purposes.

Also, general or specific aspects of the present disclosure may be implemented in the form of a system, a device, a method, an integrated circuit, or a computer program. Alternatively, these general or specific aspects of the present disclosure may be implemented in the form of an optical disc that stores such computer program or a non-transitory computer readable recording medium such as an HDD and a semiconductor memory. These general and specific aspects may also be implemented using any combination of systems, devices, methods, integrated circuits, or computer programs.

Also note that the foregoing embodiment allows for various modifications, replacements, additions, omissions, and so forth made thereto within the scope of the claims and its equivalent scope.

### INDUSTRIAL APPLICABILITY

The present disclosure is applicable for use, for example, as an information processing method capable of accurately determining whether a setup time is anormal. Example applications of the present disclosure also include a management device, an analysis device, a support device, and so forth for a production system in a factory, etc.

1. An information processing method comprising:
calculating a probability density distribution of a work time that is at least part of a setup time, based on production performance data read from storage, the setup time being time taken for a setup work that is performed between lots;
determining whether the work time is anormal, based on the probability density distribution; and
outputting a result of the determining.

2. The information processing method according to claim 1,
wherein the setup time includes:
a first work time taken for post-processing of a first lot;
a second work time taken for preparation to manufacture a second lot that is manufactured subsequently to the first lot; and
a third work time that is between the first work time and the second work time,
the calculating includes calculating a probability density distribution of each of the first work time, the second work time, and the third work time, and
the determining includes:
calculating the first work time, the second work time, and the third work time, based on a work condition of the setup time; and
determining whether each of the first work time, the second work time, and the third work time calculated is anormal.

3. The information processing method according to claim 2,
wherein the work condition is defined by a plurality of items including the first lot, the second lot, equipment that manufactures the first lot and the second lot, and a worker who conducts the setup work.

4. The information processing method according to claim 1,
wherein the calculating further includes calculating a probability density distribution of a process lead time, based on the production performance data, the process lead time being time including the setup time and a manufacturing time taken to manufacture one of the lots that is manufactured immediately after the setup time, and
the determining further includes determining whether the process lead time is anormal, based on the probability density distribution of the process lead time.

5. The information processing method according to claim 4,
wherein the determining further includes:
calculating a degree of impact of the work time on an anomaly of the process lead time, based on the probability density distribution of each of the process lead time and the work time, when the process lead time is determined to be anormal; and
determining whether the work time is anormal, based on the degree of impact calculated.

6. The information processing method according to claim 4,
wherein the manufacturing time includes:
an operating time of equipment that manufactures the lots;
a stoppage loss time caused by stoppage of the equipment; and
a defect loss time caused by the equipment having manufactured defective products,
the calculating further includes calculating a probability density distribution of each of the operating time, the stoppage loss time, and the defect loss time, based on the production performance data, and
the determining further includes:
calculating a degree of impact of each of the operating time, the stoppage loss time, and the defect loss time on an anomaly of the process lead time, based on the probability density distribution of each of the process lead time, the operating time, the stoppage loss time, and the defect loss time, when the process lead time is determined to be anormal; and
determining whether each of the operating time, the stoppage loss time, and the defect loss time is anormal, based on the degrees of impact calculated.

7. The information processing method according to claim 4,
wherein in the calculating, the probability density distribution of the process lead time is calculated by obtaining a sum of (i) a distribution obtained by multiplying, by a total number of conforming products, a probability density distribution of a takt time taken to manufacture one conforming product, (ii) the probability density distribution of the setup time, and (iii) a predetermined correction parameter.

8. A non-transitory computer-readable recording medium having recorded thereon a program for causing a computer to execute the information processing method according to claim 1.

9. An information processing device comprising:
a calculator that calculates a probability density distribution of a work time that is at least part of a setup time, based on production performance data read from storage, the setup time being time taken for a setup work that is performed between lots;
a determiner that determines whether the work time is anormal, based on the probability density distribution; and
an outputter that outputs a determination result of the determiner.
